(19) United States
(12) Patent Application Publication
(10) Pub. No.: US 2019/0265342 A1
(43) Pub. Date: Aug. 29, 2019

(54) DIAPHRAGM CUP FOR AN ULTRASONIC TRANSDUCER AND ULTRASONIC TRANSDUCER

(71) Applicant: Robert Bosch GmbH, Stuttgart (DE)

(72) Inventors: Bayar Bayarsaikhan, Leonberg (DE); David Weidenfelder, Leonberg (DE)

(21) Appl. No.: 16/347,084

(22) PCT Filed: Sep. 25, 2017
(86) PCT No.: PCT/EP2017/074149

§ 371 Date: May 2, 2019

(30) Foreign Application Priority Data
Nov. 3, 2016 (DE) 10 2016 221 542.6

(51) Int. Cl. G01S 7/521; G10K 9/122; G10K 9/22

(52) U.S. Cl. CPC G01S 7/521; G10K 9/22; G10K 9/122

(57) ABSTRACT

A diaphragm cup is described for an ultrasonic transducer, having a blind-hole-shaped recess that is delimited by a side wall and by a bottom region, the bottom region being embodied for fastening of a transducer element, the recess having, in a cross-sectional plane disposed perpendicularly to a longitudinal axis of the diaphragm cup, an oval inner contour having a major axis and a minor axis.

### FIELD OF THE INVENTION

The present invention relates to a diaphragm cup for an ultrasonic transducer. The present invention further relates to an ultrasonic transducer having a diaphragm cup.

### BACKGROUND INFORMATION

A diaphragm cup for a ultrasonic transducer is known from German Published Patent Application No. 10 2006 050 037. A number of stipulations or properties must be complied with when embodying or designing a diaphragm cup of this kind, relating e.g. to the capability of being able to manufacture the diaphragm cup as inexpensively as possible with a compact configuration, to the diaphragm cup's property of being able to radiate acoustic vibrations in a desired direction, and to the property of transferring as little energy as possible from the diaphragm cup, via the housing of the ultrasonic transducer which receives the diaphragm cup, to the body structure of a vehicle, for example in order to avoid the reception of spurious signals or the like. The diaphragm cup must furthermore be configured in the region of its diaphragm bottom to receive a transducer element, usually in the form of a piezo element. For optimum compliance with the stipulations recited above, provision is made in the context of the known diaphragm cup that the latter has, in the context of a round outer contour, an oval inner contour that has, in the region of the two longer sides of the oval contour, circular-arc-shaped portions projecting radially outward (with reference to a longitudinal axis of the diaphragm cup). The circular-arc-shaped portions just recited make possible in particular the placement or reception of the aforementioned transducer element.

### SUMMARY

The diaphragm cup according to the present invention for an ultrasonic transducer has the advantage that the aforementioned stipulations or desired properties are optimized in terms of the best possible acoustic decoupling of the diaphragm cup from the housing, i.e. avoiding the transfer of acoustic waves to the body structure, and in terms of desired ultrasonic wave emission characteristics simultaneously with relative inexpensive manufacturability of the diaphragm cup.

Provision is made for this purpose according to the present invention that the inner contour of the recess of the diaphragm cup is embodied at least approximately elliptically in a cross-sectional plane disposed perpendicularly to the longitudinal axis of the diaphragm cup. It has been found that approximating the inner contour to an ellipse in particular optimizes the desired emission characteristics, with which a relative wide emission angle in a horizontal plane and a relatively narrow emission angle in a vertical plane (as compared with the horizontal plane) are achievable. A minimization of energy coupling into the side wall of the diaphragm cup is also achieved, i.e. emission of the acoustic vibrations occurs, as desired, principally perpendicularly to the plane of the diaphragm bottom. An ideal elliptical contour is, however, relatively difficult to realize in the context of the other boundary conditions, in particular the possibility of achieving integration of the transducer element (piezo element) on the diaphragm bottom in the context of a compact diaphragm cup. An inner contour that is optimized for practical use therefore usually deviates somewhat from the ideal elliptical contour.

In order to implement the aforesaid reception of the transducer element (piezo element) in the context of a diaphragm cup that is as compact as possible in terms of its outside dimensions, provision is made that the inner contour, which is embodied at least approximately elliptically, has in the direction of the minor axis, in mirror-image fashion with respect to the major axis, a respective center portion that is embodied in locally curved fashion.

For maximum adaptation of the inner contour to the (ideal) elliptical shape, as required on the basis of the installation or disposition of the transducer element, provision is furthermore made that the maximum extent of the inner contour in the direction of the major axis and of the minor axis coincides with the contour of an (ideal) ellipse.

In practice, an inner contour has proven to be particularly favorable when it has, considered in the direction of the major axis, outside the curved center portion (which serves or is adapted to receive the transducer element), a first contour portion that proceeds outside the ideal elliptical contour; and when the first contour portion is adjoined, on the side facing away from the curved center portion, by a second contour portion that proceeds inside the ideal elliptical contour and coincides with the ideal elliptical contour in the region of the maximum extent in the direction of the major axis.

In order to embody a specific, always identical spacing between the inner contour of the diaphragm cup and the transducer element when the transducer element is of circular configuration, provision is made that the inner contour is embodied in the region of the (curved) center portion in the shape of a circular-arc portion.

The invention furthermore encompasses an ultrasonic transducer having a diaphragm cup according to the present invention as hitherto described. An ultrasonic transducer of this kind is notable for optimized functionality with relatively inexpensive manufacturability.

### BRIEF DESCRIPTION OF THE DRAWINGS

FIG. 1 is a simplified longitudinal section through a diaphragm cup constituting a constituent of an ultrasonic transducer.

FIG. 2 is a perspective view of the diaphragm cup in accordance with FIG. 1, without a transducer element disposed therein.

FIG. 3 is a section in plane of FIG. 1.

FIG. 4 is a longitudinal semi-section of the diaphragm cup in accordance with FIGS. 1 and 2 in order to illustrate the vibration characteristics of the diaphragm cup as compared with a diaphragm cup in accordance with the existing art.

### DETAILED DESCRIPTION

Elements that are the same or have the same function are labeled in the Figures with the same reference numbers.

The Figures depict a diaphragm cup 10 for an ultrasonic transducer (not depicted), the ultrasonic transducer in particular being disposed in the region of a bumper of a motor vehicle and being a constituent of a driver assistance system for detecting objects and their distance from the bumper. Diaphragm cup 10 depicted in the Figures is connected to a housing (not depicted) of the ultrasonic transducer which, in the installed state, is at least indirectly connected to the aforesaid bumper.

Diaphragm cup 10, which is made of metal and is substantially pot-shaped, is manufactured using the deep-drawing or cold extrusion method and has a longitudinal axis 11. A side wall 12 concentrically surrounds longitudinal axis 11. Diaphragm cup 10 is furthermore delimited at one end face by a bottom region 13 or diaphragm bottom, and has at the other end face a radially outwardly projecting encircling flange 14. Outer contour 16 of diaphragm cup 10, or its cross section, is embodied circularly, and the blind-hole-shaped recess 18 that is delimited by side wall 12 and bottom region 13 has on its inner side a conically embodied transition region 19.

Whereas wall thickness d of side wall 12 is at least approximately constant when considered in the direction of longitudinal axis 11, except in the region of flange 14 and in bottom region 13, wall thickness d changes when considered in a circumferential direction of side wall 12.

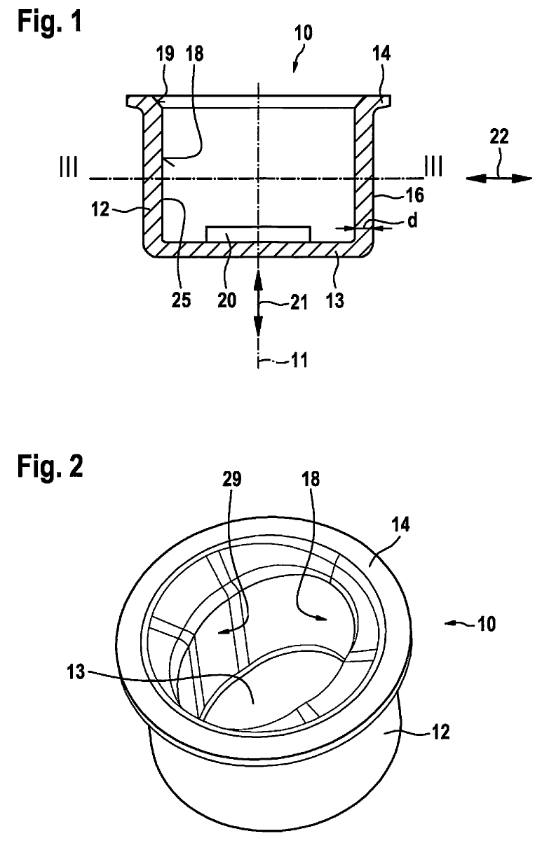

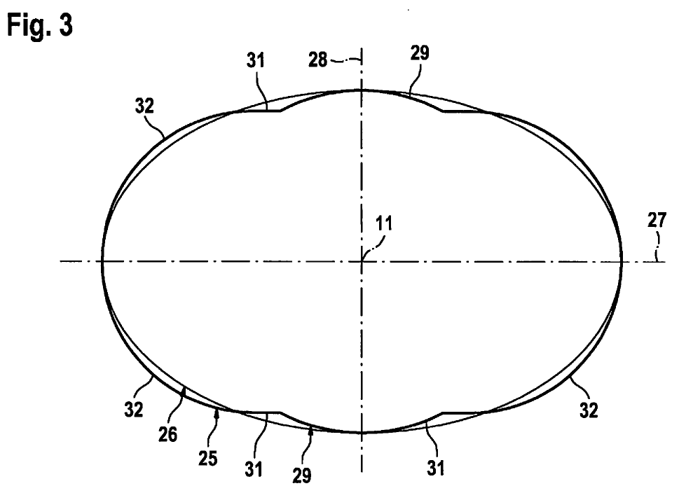

A transducer element 20 depicted only in FIG. 1, in particular in the form of a piezo actuator, is disposed inside recess 18 and is connected fixedly and in particular rigidly to bottom region 13 by way of an adhesive layer (not depicted) or the like. By way of transducer element 20, bottom region 13 is excited to vibrate during a transmission phase in a vibration direction disposed in the direction of longitudinal axis 11, in accordance with double arrow 21. Because of the rigid coupling of bottom region 13 to side wall 12, side wall 12 is thereby also excited in that context to vibrate but to vibrate transversely, as is intended to be illustrated by double arrow 22.

Whereas outer contour 16 of diaphragm cup 10 is embodied to be at least approximately round or circular, as explained above, inner contour 25 of diaphragm cup 10 is embodied to be at least approximately elliptical, at least in the region between flange 14 and bottom region 13. The exact shape of inner contour 25 as compared with an ideal contour 26 of an ellipse is depicted in more detail in FIG. 3. It is apparent in particular that inner contour 25 has a major axis 27 and a minor axis 28 that are disposed perpendicularly to one another, the intersection point of major axis 27 with minor axis 28 being coincident with longitudinal axis 11 of diaphragm cup 10. It is furthermore apparent that when considered in the direction of minor axis 28, two center portions 29 embodied in the form of circular arc portions are provided symmetrically with respect to major axis 27. When transducer element 20 is installed, these center portions 29 are preferably at a constant distance from the outer periphery of the (circular or disk-shaped) transducer element 20. The two center portions 29 proceed in particular within the (ideally elliptical) contour 26. A contour portion 31, which is disposed inside contour 26, extends from the two center portions 29 when considered in the direction of major axis 27. Adjoining contour portion 31 in the direction of major axis 27 is a further contour portion 32 that is characterized in that further contour portion 32 proceeds outside contour 26 of the ideal ellipse. It is furthermore characteristic of inner contour 25 that the maximum extent of inner contour 25 in the region of major axis 27 and minor axis 28 coincides with the maximum extent of the (elliptical) contour 26.

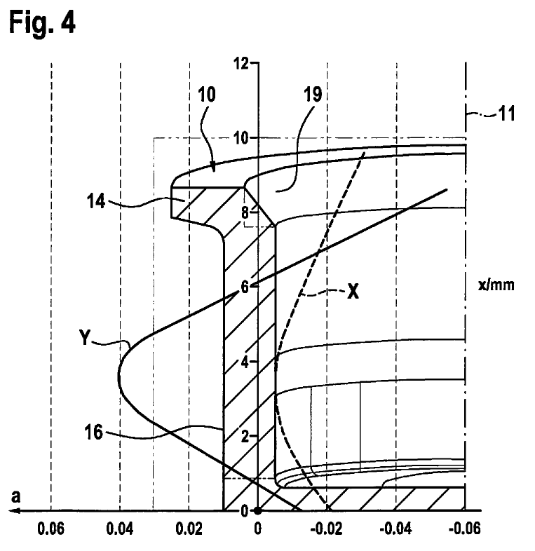

FIG. 4 illustrates the advantage of an at least approximately elliptical inner contour 25 as hitherto described, as compared with a conventional contour in accordance with the existing art, in the context of a vibrational excitation of diaphragm cup 10 by a transducer element 20. It is apparent here in particular that vibration amplitude a of side wall 12 in graph X of a diaphragm cup 10 according to the present invention is significantly less, when considered in a radial direction of diaphragm cup 10, than vibration amplitude a in graph Y of the side wall of a conventional diaphragm cup. In other words, this means that the vibration energy transferring from transducer element 20 into diaphragm cup 10 occurs, as desired, substantially in the direction of longitudinal axis 11 and not in a direction that proceeds perpendicularly to longitudinal axis 11, i.e. coupled into side wall 12. In particular, thanks to these emission characteristics, no acoustic waves, or less-disruptive ones, are also detected by a further diaphragm cup 10 or ultrasonic transducer disposed next to diaphragm cup 10, as compared with a conventional diaphragm cup.

Diaphragm cup 10 hitherto described, or its geometry, can deviate at least slightly from the geometry hitherto described without deviating from the concept of the invention. That concept consists in embodying inner contour 25 of diaphragm cup 10 at least approximately elliptically.

1.-10. (canceled)

11. A diaphragm cup for an ultrasonic transducer, comprising:
a body having a blind-hole-shaped recess that is delimited by a side wall and by a bottom region for fastening a transducer element, wherein:
the recess includes, in a cross-sectional plane disposed perpendicularly to a longitudinal axis of the diaphragm cup, an oval inner contour having a major axis and a minor axis, and
the inner contour is embodied at least approximately elliptically.

12. The diaphragm cup as recited in claim 11, wherein the inner contour has in a direction of the minor axis, in mirror-image fashion with respect to the major axis, a respective center portion that is embodied in locally curved fashion.

13. The diaphragm cup as recited in claim 12, wherein a maximum extent of the inner contour in a direction of the major axis and of the minor axis coincides with a contour of an ellipse.

14. The diaphragm cup as recited in claim 13, wherein:
the center portion is curved,
the inner contour has, considered in the direction of the major axis, outside the curved center portion, a first contour portion that proceeds outside the elliptical contour; and
the first contour portion is adjoined, on a side facing away from the curved center portion, by a second contour portion that proceeds inside the elliptical contour and coincides with the elliptical contour in a region of the maximum extent in the direction of the major axis.

15. The diaphragm cup as recited in claim 3, wherein the inner contour proceeds inside the elliptical contour in the curved center portion, and coincides with the elliptical contour in a region of the maximum extent in the direction of the minor axis.

16. The diaphragm cup as recited in claim 12, wherein the inner contour is embodied in a region of the center portion in a shape of a circular-arc portion.

17. The diaphragm cup as recited in claim 11, wherein an outer contour of the diaphragm cup is embodied circularly.

18. The diaphragm cup as recited in claim 11, wherein the inner contour, considered in a direction of the longitudinal axis, has an identical size with the exception of a flange located oppositely from the bottom region.

19. The diaphragm cup as recited in claim 18, wherein the recess has a conical transition region in a region of the flange.

20. An ultrasonic transducer, comprising:
a diaphragm cup that includes:
a body having a blind-hole-shaped recess that is delimited by a side wall and by a bottom region for fastening a transducer element, wherein:
the recess includes, in a cross-sectional plane disposed perpendicularly to a longitudinal axis of the diaphragm cup, an oval inner contour having a major axis and a minor axis, and
the inner contour is embodied at least approximately elliptically.
